(19) United States
(12) Patent Application Publication
(10) Pub. No.: US 2026/0043976 A1
(43) Pub. Date: Feb. 12, 2026

(54) OPTICAL MODULE AND OPTICAL TRANSMISSION ASSEMBLY INCLUDING CONNECTOR HOLDER

(71) Applicant: Global Technology Inc., Ningbo (CN)

(72) Inventors: PengBin LIN, Ningbo (CN); Qilin HONG, Ningbo (CN); Taotao YE, Ningbo (CN); Xin ZHANG, Ningbo (CN)

(21) Appl. No.: 18/909,834

(22) Filed: Oct. 8, 2024

(30) Foreign Application Priority Data
Aug. 12, 2024 (CN) 202411096269.4

(51) Int. Cl. G02B 6/42

(52) U.S. Cl. CPC G02B 6/4278; G02B 6/424; G02B 6/4257

(57) ABSTRACT

The present disclosure provides an optical transmission assembly, including a substrate, an optical transmission module, a holder, a plurality of multi-fiber connectors, and a plurality of adapters. The holder is coupled to the substrate, and the holder includes a plurality of holding parts. The plurality of multi-fiber connectors are optically coupled to the optical transmission module. The plurality of adapters accommodate the plurality of multi-fiber connectors, respectively, and the plurality of adapters are coupled to the plurality of holding part, respectively.

### CROSS-REFERENCE TO RELATED APPLICATIONS

This non-provisional application claims priority under 35 U.S. C. § 119(a) on Patent Application No(s). 202411096269.4 filed in China on August 12th, 2024, the entire contents of which are hereby incorporated by reference.

### BACKGROUND

### Technical Field

The present disclosure relates to an optical transmission assembly and an optical module.

### Related Art

Optical modules can transmit and/or receive optical signals for various applications including, but not limited to, internet data center, Cable TV, and fiber to the home (FTTH). Using optical modules for transmission can provide higher transmission rates and signal bandwidth over longer transmission distances. In order to enhance the compatibility of optical internetworking products all over the world and to reduce the burden of maintenance, organizations such as Multi-Source Agreement (MSA), Institute of Electrical and Electronic Engineers (IEEE), and Optical Internetworking Forum (OIF) have developed several form factors adapted to different signal transmission rates. These form factors include, but not limited to, XFP, SFP, QSFP (Quad Small Form Factor Pluggable), QSFP-DD (Double Density), OSFP (Octal Small Form Factor Pluggable), and CPO (Co-Packaged Optics).

However, conventional optical modules still present some problems, such as optical power, space management, thermal management, insertion loss, and manufacturing yield.

### SUMMARY

According to one embodiment of the present disclosure, an optical transmission assembly includes a substrate, an optical transmission module, a holder, a plurality of multi-fiber connectors, and a plurality of adapters. The holder is coupled to the substrate, and the holder includes a plurality of holding parts. The plurality of multi-fiber connectors are optically coupled to the optical transmission module. The plurality of adapters receive the plurality of multi-fiber connectors, respectively, and the plurality of adapters are coupled to the plurality of holding part, respectively.

According to another embodiment of the present disclosure, an optical module includes a housing, a substrate, an optical transmission module, a holder, a plurality of multi-fiber connectors, and a plurality of adapters. The substrate, the optical transmission module, and the holder is disposed in the housing. The holder includes a plurality of holding parts. The plurality of multi-fiber connectors are optically coupled to the optical transmission module. The plurality of adapters receive the plurality of multi-fiber connectors, respectively, and the plurality of adapters are coupled to the plurality of holding part, respectively.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is a perspective view of an optical transmission assembly according to one embodiment of the present disclosure;

FIG. 2 is another perspective view of the optical transmission assembly in FIG. 1;

FIG. 3 is an exploded view of the optical transmission assembly in FIG. 1;

FIG. 4 is a front view of the optical transmission assembly in FIG. 1;

FIG. 5 is a perspective view of a holder of the optical transmission assembly in FIG. 2;

FIG. 6 and FIG. 7 are schematic views showing an assembly process of the optical transmission assembly in FIG. 1;

FIG. 8 is a perspective view of an optical transmission assembly according to another embodiment of the present disclosure;

FIG. 9 is a perspective view of an optical transmission assembly according to still another embodiment of the present disclosure; and

FIG. 10 is an exploded view of an optical module according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

An optical module includes an optical transmitting unit and an optical receiving unit, the optical transmitting unit and the optical receiving unit are optically coupled to the optical connectors, respectively, and external optical fiber connectors may be coupled to corresponding optical connectors. In general, during the assembly of the optical module, an operator will place the optical connectors on a housing of the optical module. However, the number of the optical connectors increases as a transmission rate and a channel number of the optical module increase. For example, a high-speed optical module may include an optical connector that is optically coupled to the optical transmitting unit and another optical connector that is optically coupled to the optical receiving unit. In this case, the operator needs to manually adjust the orientation of the optical connectors when placing the optical connectors on the housing, which makes the entire assembly process very time-consuming.

In addition, in an application where the assembly process utilizes automatic equipment to assemble components into an optical module, when the automatic equipment picks up or turn over a printed circuit board assembly (PCBA), the optical fibers which are configured to optically couple the optical connectors to the optical transmitting unit or the optical receiving unit may be damaged due to compression, tangle and/or self-twisting, thereby affecting the quality of optical transmission.

The technical problems listed above make it difficult to realize an automatic assembly of the optical module.

According to an embodiment of the present disclosure, a holder which may be accommodated in the optical module is provided, and the adapter for receiving the optical connectors is coupled to the holder. Therefore, before the optical connectors are assembled with the housing of the optical module, the orientation and the position of the optical connectors are pre-determined, allowing the operator to quickly complete the assembly process for the optical connectors and the housing.

In addition, in an application where the assembly process utilizes automatic equipment to assemble the components into an optical module, because the optical connectors, which are optically coupled to the optical fibers, are coupled to the holder by the adapter, the optical fibers will also be lifted or turned over as the PCBA is picked up or turned over, thereby preventing it from being damaged due to compression, tangle and/or self-twisting.

As a result, the automatic assembly of the adapter and the holder may be realized, the holder also facilitates the automatic assembly of the substrate and the optical transmission module, and the automatic testing of the optical transmission assembly may be realized before the optical transmission assembly is assembled with the housing.

Some or all of the technical features disclosed in one or more embodiments of the present disclosure may be combined to achieve corresponding effects.

The term “couple” or “coupled to” refers to any connection, link, or the like. Moreover, the term “optically couple” or “optically coupled to” refers to a relationship where light is transmitted (imparted) from a device to another. Unless otherwise specified, devices that “couple” or “coupled to” each other do not need to be directly connected to each other and may be separated by intervening objects.

The term substantially, as generally referred to herein, refers to a degree of precision within acceptable tolerance that accounts for and reflects minor real-world variation due to material composition, material defects, and/or limitations/peculiarities in manufacturing processes. Such variation may therefore be said to achieve largely, but not necessarily wholly, the stated characteristic.

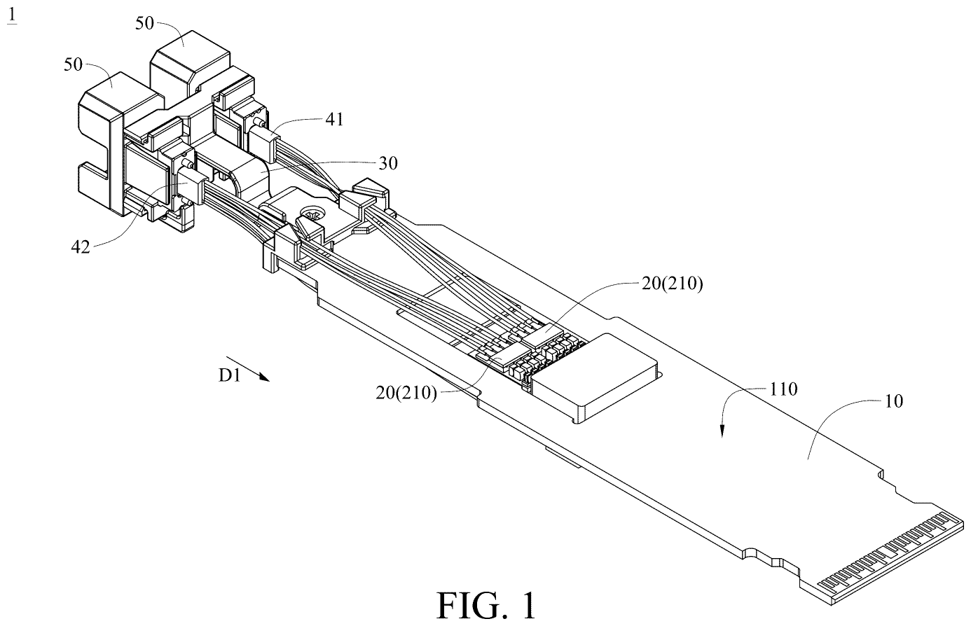

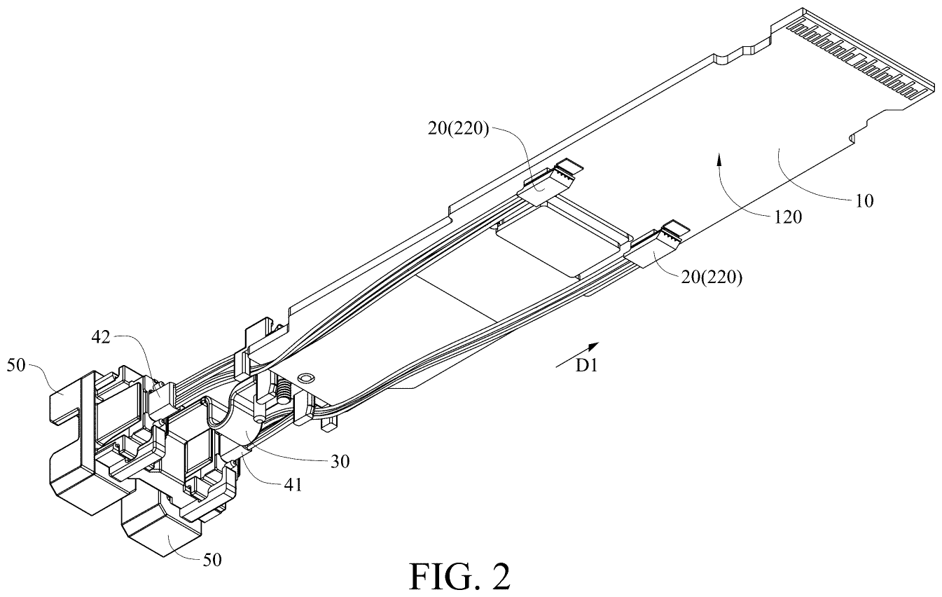

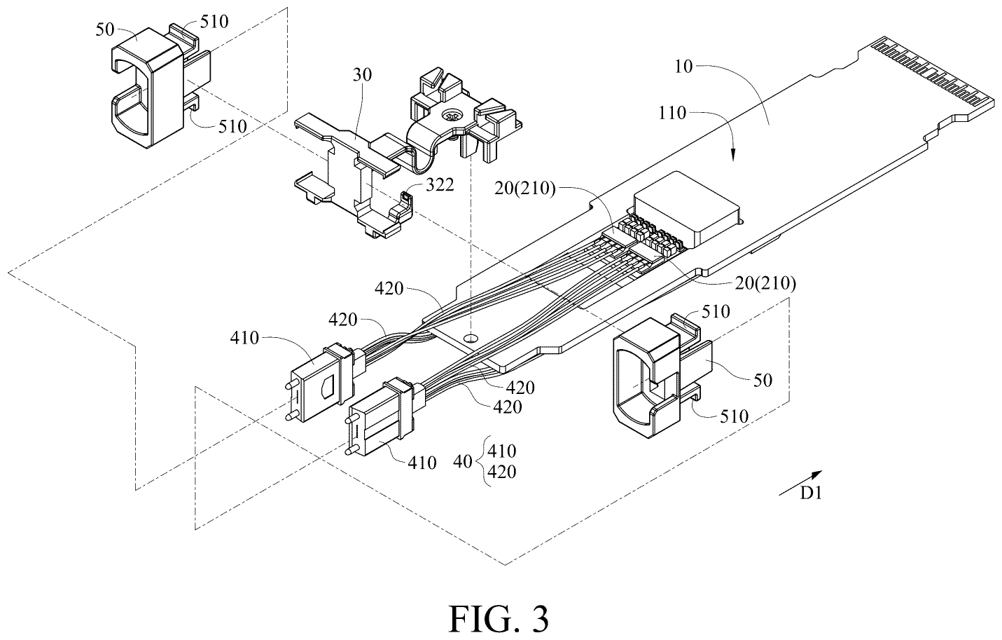

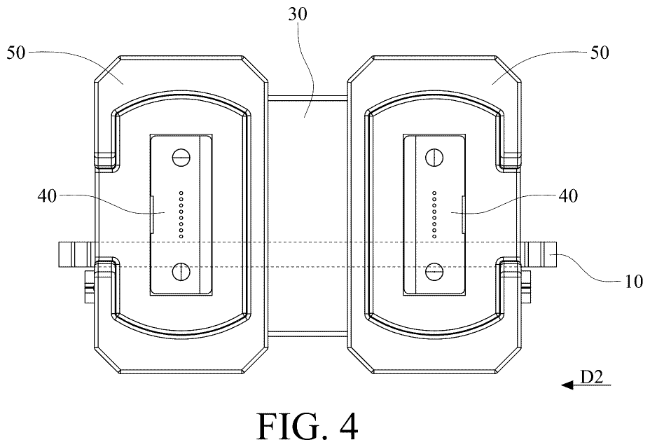

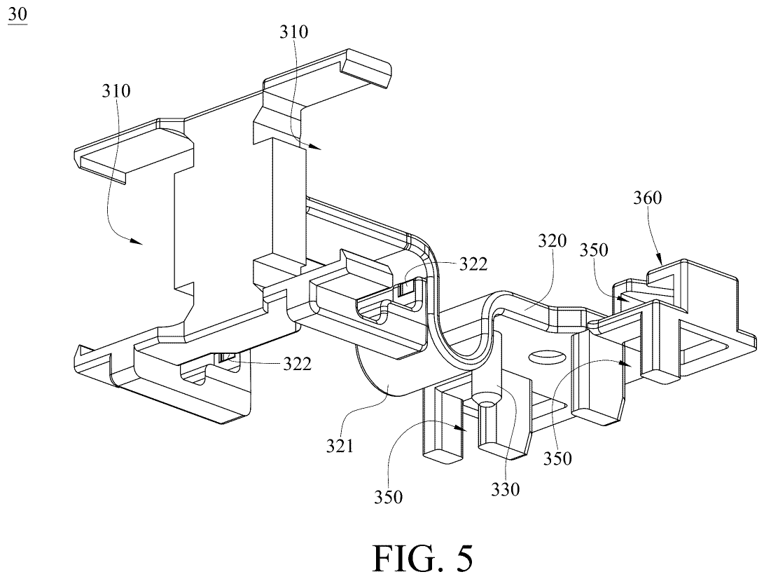

FIG. 1 is a perspective view of an optical transmission assembly 1 according to one embodiment of the present disclosure, FIG. 2 is another perspective view of the optical transmission assembly 1 in FIG. 1, FIG. 3 is an exploded view of the optical transmission assembly 1 in FIG. 1, FIG. 4 is a front view of the optical transmission assembly 1 in FIG. 1, and FIG. 5 is a perspective view of a holder 30 of the optical transmission assembly 1 in FIG. 2. According to an embodiment, the optical transmission assembly 1 may include a substrate 10, an optical transmission module 20, the holder 30, a plurality of multi-fiber connectors 40, and an adapter 50.

Please refer to FIGS. 1 and 2. In one embodiment, the substrate 10 is a PCBA. In one embodiment, the substrate 10 is a metal housing. In one embodiment, the substrate 10 is a baseplate configured to support an optical passive component, and the baseplate is coupled to the PCBA.

In one embodiment, the optical transmission module 20 is coupled to the substrate 10. In one embodiment, the optical transmission module 20 includes one or more optical transmitting units 210 and one or more optical receiving units 220, where each optical transmitting unit 210 includes one or more laser diodes, and each optical receiving unit 220 includes one or more photodiodes. In one embodiment, each of the optical transmitting unit 210 and the optical receiving unit 220 further includes an optical passive component, such as but not limited to an optical isolator, an optical fiber array, a wavelength division multiplexer, a wavelength division demultiplexer, and a focusing lens. In one embodiment, each optical transmitting unit 210 may be understood as a transmitter optical subassembly (TOSA), and each optical receiving unit 220 may be understood as a receiver optical subassembly (ROSA). The optical transmitting unit 210 may be hermetically or non-hermetically sealed and mounted on the substrate 10. The optical receiving unit 220 may be hermetically or non-hermetically sealed and mounted on the substrate 10.

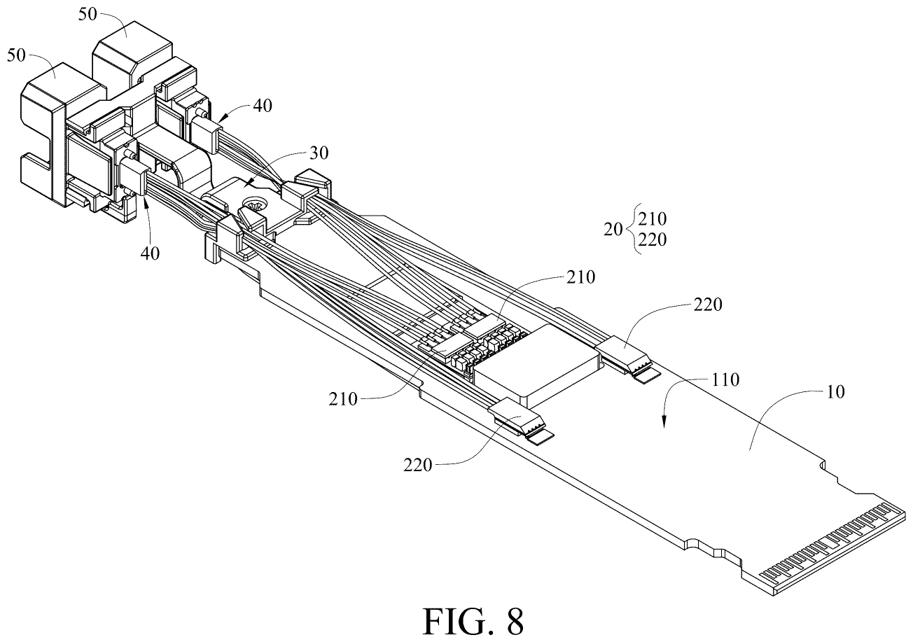

In one embodiment, all of the optical transmitting units 210 and all of the optical receiving units 220 are disposed on an upper surface 110 of the substrate 10. In one embodiment, at least one optical transmitting unit 210 and at least one optical receiving unit 220 are disposed on the upper surface 110 of the substrate 10, and another optical transmitting unit 210 and another optical receiving unit 220 are disposed on a lower surface 120 of the substrate 10. In one embodiment, all of the optical transmitting units 210 and all of the optical receiving units 220 are disposed on the lower surface 120 of the substrate 10. Please refer to FIGS. 1 and 2. In one embodiment, all of the optical transmitting units 210 are disposed on the upper surface 110 of the substrate 10, and all of the optical receiving units 220 are disposed on the lower surface 120 of the substrate 10. Please refer to FIG. 8. FIG. 8 is a perspective view of an optical transmission assembly 1 according to another embodiment of the present disclosure, where the two optical transmitting units 210 and the two optical receiving units 220 are disposed on the upper surface 110 of the substrate 10.

According to one embodiment, the holder 30 may be coupled to the substrate 10. Please refer to FIG. 2, in one embodiment, the holder 30 is screwed to the substrate 10. In one embodiment, the holder 30 is adhered to the upper surface 110 or the lower surface 120 of the substrate 10. In one embodiment, the holder 30 is formed as a single piece.

According to an embodiment, the adapters 50 may receive the multi-fiber connectors 40, respectively. In one embodiment, each the multi-fiber connector 40 may include a main body 410 and multiple optical fibers 420 that are coupled to the main body 410. In one embodiment, the main body 410 is a plastic housing with MT ferrule. In one embodiment, the multiple optical fibers 420 extend through a corresponding main body 410. In one embodiment, the optical fibers 420 of each multi-fiber connector 40 are optically coupled to the optical transmission module 20. In one embodiment, the multi-fiber connector 40 is an MPO connector. Please refer to FIG. 3, in one embodiment, the multi-fiber connector 40 is an MPO male connector. In one embodiment, the optical fiber 420 optically coupled to the optical transmitting unit 210 is configured to transmit optical signals generated by the optical transmitting unit 210 to the corresponding multi-fiber connector 40, and the optical fibers 420 optically coupled to the optical receiving unit 220 are configured to transmit optical signals to the optical receiving unit 220 therethrough. Please refer to FIG. 3, in one embodiment, the adapter 50 is sleeved on the main body 410 of the multi-fiber connector 40.

According to an embodiment, the adapters 50 may be coupled to the holder 30. In one embodiment, the holder 30 may include a plurality of holding parts 310, and the adapters 50 are coupled to the holding parts 310. Please refer to FIGS. 3 and 5, in one embodiment, each holding part 310 may be a snap ring, and the adapter 50 is engaged with the snap ring. In one embodiment, each holding part 310 may include a supporting plate, and the adapter 50 is fixed to the supporting plate. In one embodiment, each holding part 310 may include a recess, and the adapter 50 is accommodated in the recess. Please refer to FIG. 2, in one embodiment, the optical transmission assembly 1 includes a first multi-fiber connector 41 that is optically coupled to one optical transmitting unit 210 and one optical receiving unit 220, and a second multi-fiber connector 42 that is optically coupled to another optical transmitting unit 210 and another optical receiving unit 220.

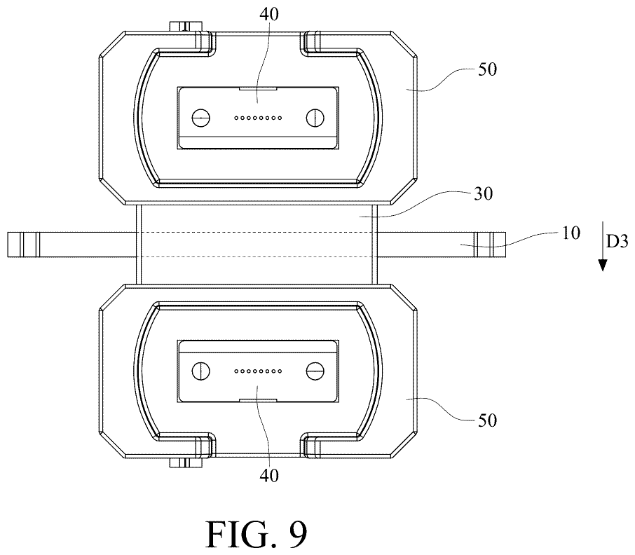

Please refer to FIG. 4. In one embodiment, the multi-fiber connectors 40 may be substantially arranged in a transverse direction D2 of the optical transmission assembly 1. In one embodiment, the multi-fiber connectors 40 are substantially arranged in a vertical direction of the optical transmission assembly 1. FIG. 9 is a perspective view of an optical transmission assembly 1 according to still another embodiment of the present disclosure, where the multi-fiber connectors 40 are substantially arranged in a vertical direction D3 of the optical transmission assembly 1.

According to an embodiment, the holder 30 may include a positioning pillar 330, and the positioning pillar 330 may be disposed between the substrate 10 and the multi-fiber connectors 40. The specific usage of the positioning pillar 330 are described later.

According to an embodiment, the holder 30 may include a linkage arm 320 that is disposed between the substrate 10 and the multi-fiber connectors 40. In one embodiment, the linkage arm 320 is disposed between the substrate 10 and the multi-fiber connectors 40. In one embodiment, the holding parts 310 of the holder 30 are coupled to the linkage arm 320. In one embodiment, the linkage arm 320 has a bending part 321. Please refer to FIGS. 2 and 5, in one embodiment, the positioning pillar 330 is disposed between the bending part 321 and the substrate 10. The specific usage of the bending part 321 are described later.

According to an embodiment, the holder 30 may include at least one wire management recess 350, and the optical fibers 420 of the multi-fiber connector 40 may be disposed in the wire management recess 350. In one embodiment, the wire management recess 350 is coupled to the linkage arm 320. Please refer to FIG. 5. In one embodiment, the holder 30 includes four wire management recesses 350, where the optical fibers 420 that are optically coupled to the optical transmitting units 210 are disposed in two of the wire management recesses 350, and the optical fibers 420 that are optically coupled to the optical receiving units 220 are disposed in the other two of the wire management recesses 350. In one embodiment, the holder 30 may further include a retaining structure 360 that is disposed adjacent to the wire management recess 350, where the retaining structure 360 may prevent the optical fibers 420 from detaching from the wire management recess 350. Please refer to FIG. 5. In one embodiment, the retaining structure 360 includes a hook that is disposed above the wire management recess 350.

According to an embodiment, each adapter 50 may include a stopping part 510, and the corresponding holding part 310 may spatially interfere with the stopping part 510 in a longitudinal direction D1 of the optical transmission assembly 1. Please refer to FIGS. 1 and 3, in one embodiment, for a corresponding set of the adapter 50 and the holding part 310, the holding part 310 substantially and spatially interferes with the stopping part 510 of the adapter 50 in the longitudinal direction D1 so that a movement of the adapter 50 that is sleeved on this multi-fiber connector 40 is limited in the longitudinal direction D1.

According to an embodiment, each holding part 310 of the holder 30 may include a stopping part 322, and the stopping part 322 spatially interferes with the main body 410 of the multi-fiber connector 40 in the longitudinal direction D1 of the optical transmission assembly 1. Please refer to FIGS. 1 and 3, in one embodiment, for a corresponding set of the multi-fiber connector 40 and the holding part 310, the stopping part 322 substantially and spatially interferes with the main body 410 in the longitudinal direction D1 so that a movement of the multi-fiber connector 40 is limited in the longitudinal direction D1.

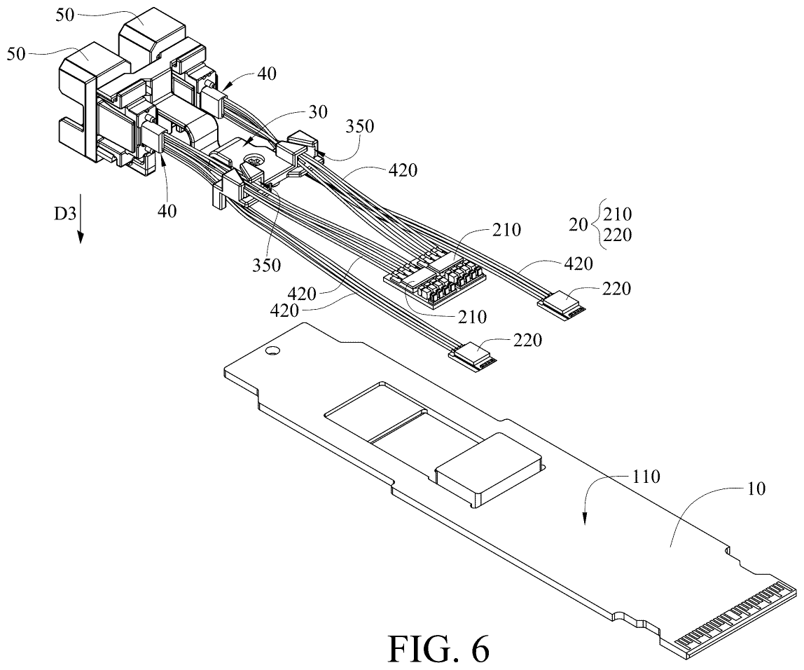

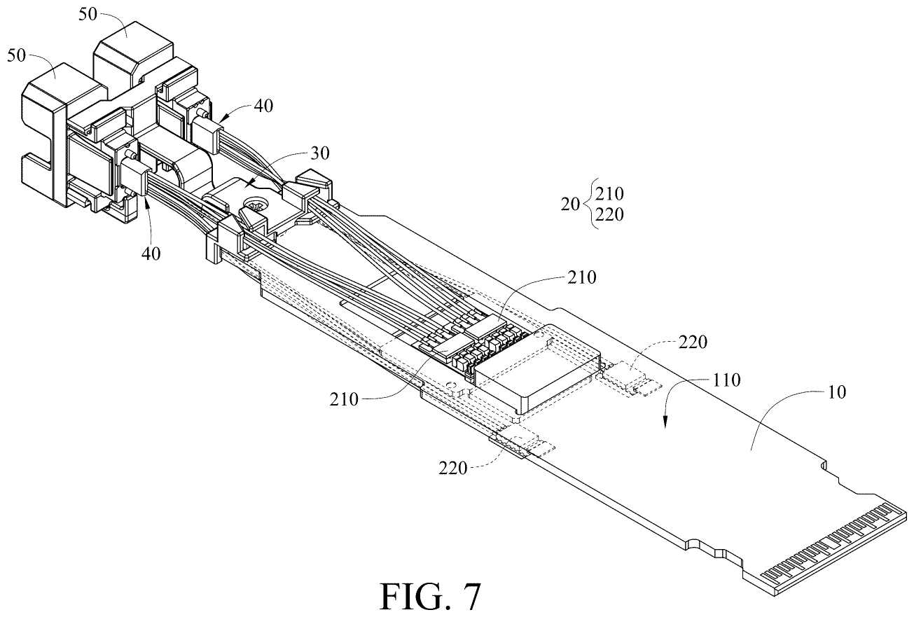

FIG. 6 and FIG. 7 are schematic views showing an assembly of the optical transmission assembly 1 in FIG. 1. Firstly, please refer to FIG. 6. The multi-fiber connector 40 is accommodated in the adapter 50, the adapter 50 is engaged with the corresponding holding part 310, and the optical fibers 420 of the multi-fiber connector 40 are placed in the wire management recess 350. Secondly, please refer to FIG. 7. The optical transmission module 20 (the optical transmitting unit 210 and the optical receiving unit 220) is placed on the substrate 10 along the vertical direction D3. In one embodiment, the optical transmitting unit 210 and the optical receiving unit 220 are adhered to the substrate 10. In one embodiment, the adapter 50 may also receive an external optical connector (such as an MPO female connector, not shown) so that the external optical connector is optically coupled to the multi-fiber connector 40.

In order to facilitate the assembly, a jig (not shown) that is coupled to the holding part 310 may be additionally provided, and this jig may be configured to support the optical transmission module 20. When the optical fibers 420 are going to be placed in the wire management recess 350, the optical transmission module 20 can be supported on the jig. Then, the optical transmission module 20 is transferred from the jig to the substrate 10, and the jig is removed. More specifically, the jig may be used as a temporary carrier before the optical transmission module 20 is mounted to the substrate 10. In one embodiment, the jig is coupled to the holder 30. In one embodiment, the positioning pillar 330 of the holder 30 is inserted into the jig, and the jig is engaged with the bending part 321 of the holder 30. Therefore, the detachable assembly of the fixture and the holder 30 is realized.

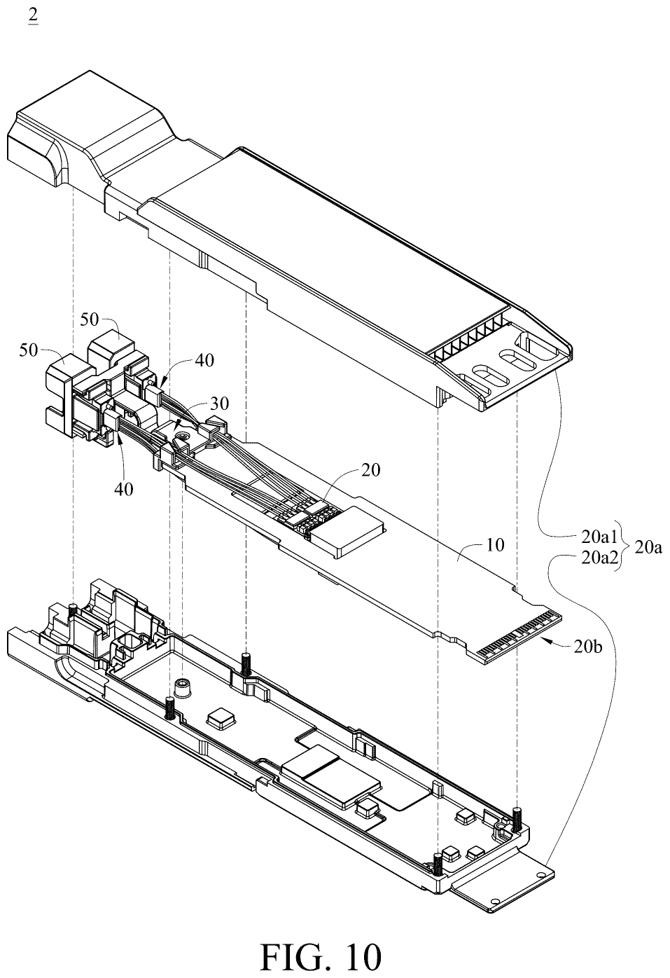

FIG. 10 is an exploded view of an optical module 2 according to one embodiment of the present disclosure. According to an embodiment, the optical module 2 may include a housing 20a and an optical transmission assembly 20b. The optical transmission assembly 20b may be the aforementioned optical transmission assembly 1 in FIG. 1, or may be the optical transmission assembly in any other embodiments.

In one embodiment, the housing 20a is integrally formed as a single piece, and the optical transmission assembly 20b is accommodated in the housing 20a. In one embodiment, the housing 20a is a multi-part housing including an upper housing part 20a1 and a lower housing part 20a2, and the upper housing part 20a1 and the lower housing part 20a2 are assembled with each other to accommodate the optical transmission assembly 20b. In one embodiment, the substrate 10, the optical transmission module 20, and the holder 30 of the optical transmission assembly 20b are disposed in the housing 20a. In one embodiment, the holder 30 and the substrate 10 are spaced apart from each other, and the holder 30 is seated on an inner surface of the housing 20a.

According to the present disclosure, the holder which may be accommodated in the optical module is provided, and the adapter that is configured to receive the optical connectors is coupled to the holder. Before the optical connectors are assemble with the housing of the optical module, the orientations and the positions of the optical connectors are pre-determined by using the additional holder to comply with the specification of the optical interface of the optical module, allowing the operator to quickly complete the assembly process for the optical connectors and the housing.

In addition, in an application where the assembly process utilizes automatic equipment assemble the components into an optical module, because the optical connectors which are optically coupled to the optical fibers are coupled to the holder by the adapter, the optical fibers will also be lifted or turned over as the PCBA is picked up or turned over, thereby preventing it from being damaged due to compression, tangle and/or self-twisting. Therefore, the holder is favorable for the neat distribution of the optical fibers, thereby improving the reliability of the optical fibers.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical transmission assembly, comprising:
a substrate;
an optical transmission module;
a holder, coupled to the substrate, wherein the holder comprises a plurality of holding parts;
a plurality of multi-fiber connectors, optically coupled to the optical transmission module; and
a plurality of adapters, receiving the plurality of multi-fiber connectors, respectively, wherein the plurality of adapters are coupled to the plurality of holding parts, respectively.

2. The optical transmission assembly according to claim 1, wherein the holder is screwed to the substrate.

3. The optical transmission assembly according to claim 1, wherein the holder further comprises a positioning pillar, and the positioning pillar is disposed between the substrate and the plurality of multi-fiber connectors.

4. The optical transmission assembly according to claim 1, wherein the holder further comprises a linkage arm that is disposed between the substrate and the plurality of multi-fiber connectors, the plurality of holding parts are coupled to the linkage arm, and the linkage arm has a bending part.

5. The optical transmission assembly according to claim 1, wherein the holder further comprises at least one wire management recess, each of the plurality of multi-fiber connectors comprises a plurality of optical fibers that are optically coupled to the optical transmission module, and the plurality of optical fibers of each of the plurality of multi-fiber connectors are disposed in the at least one wire management recess.

6. The optical transmission assembly according to claim 1, wherein each of the plurality of holding parts is a snap ring, and the plurality of adapters are engaged with the snap rings of the plurality of holding parts, respectively.

7. The optical transmission assembly according to claim 6, wherein each of the plurality of adapters comprises a stopping part, and the snap ring spatially interferes with the stopping part in a longitudinal direction of the optical transmission assembly.

8. The optical transmission assembly according to claim 1, wherein each of the plurality of holding parts comprises a stopping part, and the stopping parts of the plurality of holding parts spatially interferes with the plurality of multi-fiber connectors in a longitudinal direction of the optical transmission assembly.

9. The optical transmission assembly according to claim 1, wherein each of the plurality of multi-fiber connectors is an MPO connector.

10. An optical module, comprising:
a housing;
a substrate, disposed in the housing;
an optical transmission module, disposed in the housing;
a holder, disposed in the housing, wherein the holder comprises a plurality of holding parts;
a plurality of multi-fiber connectors, optically coupled to the optical transmission module; and
a plurality of adapters, receiving the plurality of multi-fiber connectors, respectively, wherein the plurality of adapters are coupled to the plurality of holding parts, respectively.

11. The optical module according to claim 10, wherein the holder further comprises a positioning pillar, and the positioning pillar is disposed between the substrate and the plurality of multi-fiber connectors.

12. The optical module according to claim 10, wherein the holder further comprises a linkage arm that is disposed between the substrate and the plurality of multi-fiber connectors, the plurality of holding parts are coupled to the linkage arm, and the linkage arm has a bending part.

13. The optical module according to claim 10, wherein the holder further comprises at least one wire management recess, each of the plurality of multi-fiber connectors comprises a plurality of optical fibers that are optically coupled to the optical transmission module, and the plurality of optical fibers of each of the plurality of multi-fiber connectors are disposed in the at least one wire management recess.

14. The optical module according to claim 10, wherein each of the plurality of holding parts is a snap ring, and the plurality of adapters are engaged with the snap rings of the plurality of holding parts, respectively.

15. The optical module according to claim 14, wherein each of the plurality of adapters comprises a stopping part, and the snap ring spatially interferes with the stopping part in a longitudinal direction of the optical module.

16. The optical module according to claim 10, wherein each of the plurality of holding parts comprises a stopping part, and the stopping part spatially interferes with the plurality of multi-fiber connectors in a longitudinal direction of the optical module.

17. The optical module according to claim 10, wherein each of the plurality of multi-fiber connectors is an MPO connector.
